(19) United States
(12) Patent Application Publication
(10) Pub. No.: US 2017/0013087 A1
(43) Pub. Date: Jan. 12, 2017

(54) MULTIPLE ACCOUNT REGISTRATION USING OPTICAL CODE IMAGE

(71) Applicant: THOMSON LICENSING, Issy de Moulineaux (FR)

(72) Inventor: Jason Paul Elkin, Los Angeles, CA (US)

(21) Appl. No.: 15/104,773

(22) PCT Filed: Dec. 16, 2013
(86) PCT No.: PCT/US2013/075284

§ 371 Date: Jun. 15, 2016

(51) Int. Cl. H04L 29/08; G06K 7/14; H04L 29/06; G06F 9/445

(52) U.S. Cl. CPC H04L 67/34; G06F 8/61; G06K 7/1417; G06K 7/1413; H04L 63/10

(57) ABSTRACT

A method to receive media service application program into a media playback device includes scanning a quick response (QR) code containing a universal resource locator of a first server and an identifier of the media player device. The first server is accessed and a universal resource locator is provided to the media playback device to download an appropriate media service application for the media playback device from a second server. The media playback device installs the media service application and configures it for operation by a user. Multiple media services may be encoded in a QR code for a single media playback device. Multiple media playback devices may be associated with a single media service on a QR code.

### FIELD

The present disclosure relates to the operation of multiple media devices for services in a network. Specifically, the disclosure relates to the configuration and registration of different media playback devices to access one or more multimedia services.

### BACKGROUND

The disclosure provides a simple way to register a number of media services for a consumption device instead of having to register such services individually. This becomes more of a problem when the consumption device has a user interface that is clunky to use when trying to input in user account information.

Multimedia services which can provide digital content are ubiquitous. Multimedia services such as Netflix™, Hulu™, Amazon™ Video on Demand, Vudu™, iTunes™, M-Go™ and the like can provide streaming audio and media services. Many of these services are available via a subscription to an account with the video service. Such an account requires some subscriber credentials such as a username and password to gain access to the digital content. Many different kinds of media playback devices, such as laptops, tablets, smartphones, video game systems, set-top-boxes (STD) and other personal digital devices can be used to view streamed digital content such as movies or video clips and corresponding audio. However, each of the media playback devices requires a download of software specific to the operating system of the particular device in order to receive and play back the streamed audio and video from the media service. In addition, after the correct software application (app) is loaded for the corresponding device, user credentials and other account information must be manually entered for the device to function as a playback device for content streamed by the media service.

The acts of finding, selecting, and downloading the correct version of software for a user's particular device can be a chore if the user is not familiar with the set-up process for that particular device. In addition, entry of the user credential and account information to gain access to a multimedia service provider's services can be a very cumbersome manual operation. The present invention provides a solution to ease application selection and downloading as well as registration process of an auxiliary or additional device useful for multimedia service access.

### SUMMARY

This summary is provided to introduce a selection of concepts in a simplified form that are further described below in the Detailed Description. The Summary is not intended to identify key features or essential features of the claimed subject matter, not is it intended to be used to limit the scope of the claimed subject matter.

The invention enables a user's media playback or content consumption device to use its visual sensor (such as a camera, optical sensor, and the like) to initiate a download and registration of a correct version of software to the user's playback device to permit access to a multimedia service. The appropriate versions of the client applications or web based version of such applications for the multimedia services are automatically selected for the playback device based on the attributes, such as identifier (ID) of the playback device. An optical code image, such as a bar code, Uniform Product Code (UPC), or Quick Response Code (QR) is used by a visual sensor at the playback device to set up such accounts when the optical code image is processed. The accounts are preferably related to media services.

Additional features and advantages of the invention will be made apparent from the following detailed description of illustrative embodiments which proceeds with reference to the accompanying figures.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates a system diagram that serves as an environment for the invention;

FIG. 2 illustrates a flow of activities within the environment;

FIG. 3 illustrates a flow of activities of the additional device according to aspects of the invention; and

FIG. 4 illustrates an example media playback device block diagram supporting aspects of the invention.

### DETAILED DISCUSSION OF THE EMBODIMENTS

In the following description of various illustrative embodiments, reference is made to the accompanying drawings, which form a part thereof, and in which is shown, by way of illustration, various embodiments wherein the invention may be practiced. It is to be understood that other embodiments may be utilized and structural and functional modification may be made without departing from the scope of the present invention.

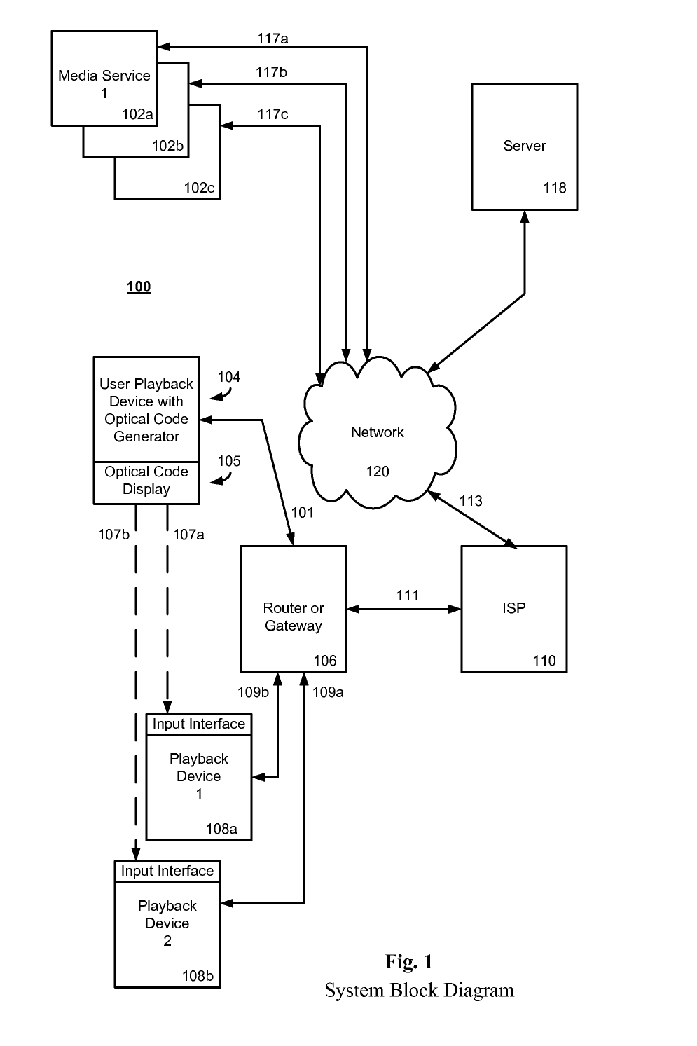

FIG. 1 depicts an environment 100 in which the invention may be practiced. The system environment includes a router/gateway 106 connected via cable or wireless connection 111 to an internet service provider (ISP) 110 enabling access via connections 113 to a network 120. The router can be a standard router that is compatible with internet service provider equipment for routing internet protocol packets or a suitable gateway or modem. The router may be either a public or a private router. The router or gateway 106 can provide access to the network 120 via wired or wireless links to multiple user equipment such as user playback device 104 or additional playback devices 108a and 108b. Although only three user playback or content consumption devices are shown, many such devices can be supported. Each properly configured playback device 104, or 108 a, b can operate independently to access a media service. Additional playback devices 108a and 108b may also be termed media playback devices, user playback devices, or auxiliary playback devices. Additional playback devices are simply playback devices that the user wishes to use to access digital media using a subscription account that the user has with a media service provider.

In one normal example operation, a first user playback device 104 communicates via link 101 with the router or gateway 106, via ISP service 110, to obtain access to the network 120. Network 120 may be a private or public network, such as a corporate network or the internet. The first playback device 104 may be a personal computer (PC) or laptop or other personal digital (PDA). The first playback device 104 can access media services such as media services 1, 2, and 3, shown in FIGS. 1 as 102a, 102b, and 102c via network connection links 117a, 117b, and 117c. In use, the playback device 104 can access the media services to view (playback) digital content, such as movies, audio, data, e-books, and the like. Multiple media services, such as 102a, 102b, and 102c for example, may be accessed by the first playback device 104. With each individual media service from different media service providers, such as Netflix, Hulu, Amazon, and M-Go, there exists separate and unique user accounts numbers and user credentials, such as user names and passwords. Accordingly, a client media application (app) dedicated to each respective media service accessed by the playback device 104 must be loaded and configured before the playback device 104 can access a specific media service.

In addition to the first playback device 104, additional, or auxiliary playback devices such 108a and 108b are also capable of accessing the media services. However, media service access to consume or playback digital content from the media services is only possible if the additional playback devices each have a media application (app) installed onto the respective device or can have access to a website of the media service being accessed. Assuming the additional playback devices are application (app) driven, their respective applications also require some configuration with either or both of user account information or user credentials to view media service provided digital content. Finding, selection, downloading, and configuring an additional playback device with the correct version of the media service application (app) that accommodates not only the additional device type but also its operating system can be time-consuming. For example, if a given computer tablet model has an Android operating system, the media services application (app) that must reside on the tablet must be compatible with that specific model of tablet as well as the specific version of Android operating system installed on the tablet. A different tablet model may operate with an IOS (Apple) operating system and thus a different version of the media services application (app) must be used in the different tablet to access a desired media service. Selection of the correct version of media service application (app) to download onto any given tablet can be a time consuming selection process for the user. An improperly selected media service application (app) may not be well suited for the device and can cause errors, may distort the operation of features, or may render the tablet inoperable. The present invention makes the media service application (app) selection process for an additional media playback device easier and error free from a user perspective. Examples of additional media playback devices or digital content consumption devices include a personal computer, touch tablet, phone, video game system, smart TV, and the like.

Once additional playback devices, such as 108a and 108b are properly configured, they are capable of accessing media services, such as networked media services 102a-c, via wired or wireless interfaces 109a and 109b respectively or via another network interface such as a mobile phone network interface (not shown).

According to an aspect of the invention, an optical code image, such as a universal product code (UPC) or quick response (QR) code, can be generated having information needed to identify a media service, respective account, and user credential information. In addition, a target additional media playback device identifier is provided to be associated with the desired media service that is to be accessed by the additional media playback device. One advantage of using an additional device identifier is that the identifier can be used to properly identify not only the device model, but also the associated operating system of the additional device. One advantage to encoding user credentials in an optical code image is to obscure the credentials from easy detection by human observers of the optical code image.

In one embodiment, the optical code image, such as a QR code, is generated via user input at the user playback device 104 in response to data received from the user. For example, if playback device 104 is a PC, it can have a QR code generator program in residence which can generate a QR code via user inputs. Here, a user enters an additional media playback device identifier, such as a model number of the additional media playback device, the desired media service, and user credentials. The information is then coded into an optical representation or image, such as that of a QR code image, a bar code image, or a UPC code image. The optical code image can be displayed 105 on the playback device 104 or any display device that is available. The optical code can then be sensed by an additional media playback device. For example, an optical code image generated by user device 104 is displayed 105 and sensed by additional playback device 108a via close proximate optical transmission path 107a. Likewise, additional playback device 108b can sense the displayed optical code image 105 by additional playback device 108b via a line of sight optical transmission path 107b. In one aspect of the invention, the same optical code image may be used to configure different devices (e.g. 108a and 108b). Alternatively, separate optical code images may be used to separately configure additional media playback devices.

It should be noted that playback device 104 is not the only optical code image generator that can be used to generate an optical code for purposes of the present invention. A separate device, such as a stand-alone PC or Server can be used to generate an optical coded image with user inputs. Display of the generated optical code image can be performed on any display of any device suitable to display such an image.

According to aspects of the invention, additional playback devices 108a-b may be loaded and configured using an optical code image sensed via respective optical input interfaces, such as camera-type sensor interfaces. The optical code image, once sensed by the respective additional playback device, instructs the additional playback device to access the network 120 via router 106 and ISP 110 to communicate with a server 118. The server 118 receives playback device identification information as well as information regarding the desired media service. This information is processed and the server which then instructs the playback device to access the correct version of media service application (app) for the specific media service selected. If multiple media services are indicated in the optical code image, then multiple instructions are provided to the playback device to download the client media applications (apps) corresponding to the requested media services. Once the correct media services are downloaded into the playback device, the playback device can be configured using the account and credential information extracted from the optical code image. In an alternate embodiment, the server 118 is not remote, but is instead located in the router or gateway 106. In this configuration (not shown), the locally implemented server behaves similarly to that of a remote server but may access the network 120 for resources such as appropriate URL references for the web site of media service application downloads.

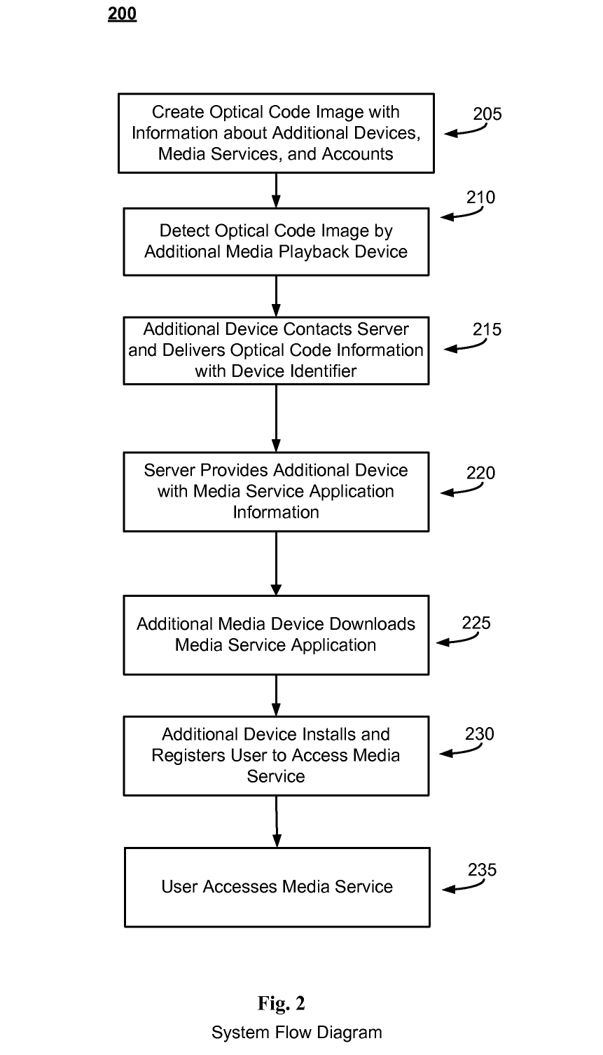

FIG. 2 is a flow diagram describing the activities within the environment of FIG. 1. The process 200 starts at step 205 with the creation of an optical code image. The optical code image may be generated to use any type of data-bearing optical code image such as a bar code, a QR code or a UPC code. QR codes, with their ability to encode large amounts of information, are especially useful. In making the QR code, information to be optically encoded into the optical code image is provided by a user or service having the desired information. The following information is an example of information to be optically encoded into an image.
Media service name, id, or locator (M-GO, Hulu, Netflix, etc.);
Account number of identifier for the media service;
Media playback device identifier, such as device name and model number; and
User credentials, such as user name and/or user password.

In one embodiment, the user may provide the media service name, account information, and device name and model number to an optical image encoder software program in order to generate the optical code image. The software program may be resident on any computerized device under the control of the user, media service provider, or another entity. In one embodiment, a local or network server, such as server 118 or a server associated with providers of media services 102 a, b, or c can provide optical code images to a user for use in configuring additional devices. In this embodiment, the user can select a target additional device from a list of devices presented to her on a PC or other computerized device with a display. The list of additional media playback devices may be generated by the media service provider and presented to a user on a media service provider web site. The selected device triggers the delivery of an optical code image, possibly generated by the media service provider or by to be delivered to the user's PC. The optical code image can then be used to configure her additional media playback devices to function with the media service.

At step 210, the optical code image is displayed on a monitor, such as a user operated PC. The display device can be any display device under the control of the user, media service provider, or another entity. The optical image can then be presented to an additional media playback device for optical code image scanning and detection to extract the encoded information. At step 215, the additional playback device contacts the server 118 to deliver the extracted optical code information such as the media service and account information and media playback device identifier. At server 118, the information from the optical code is decoded and the correct version of media service application software is determined by the server. The media service application software is a client application for the media service. The correct version of application software is based on the media playback device identifier and the media service that is specified. The proper operating system (OS) of the media playback device is relevant to the determination of the correct media service application (app) to select, but the OS may be determined from or correlated with the model number in some instances. Once the characteristics of the additional media playback device are defined, the server acts to determine the correct download software for the media service application to support the particular additional playback device. For example, if the optical information indicates that the media service of Hulu is desired on a Motorola Android mobile phone, then the appropriate version of a Hulu application (app) supporting the particular Android mobile phone and its operating system is determined by the server 118.

At step 220, the determined version of the media service application is provided to the additional playback device. Here, the server 118 may provide a universal resource locator (URL) to the additional media device specifying a location from where the latest version of the media server application (app) for the specific additional playback device may be downloaded. In one embodiment, this URL is the web address of an application server that resides or is associated with one of the media service providers 102. Here, an application server is any address-accessible device that can host and download a media service application (app) to a media playback device. In one embodiment, the application server can be within server 118. In another embodiment, the application server can reside within a respective media service provider 102. The URL provided can link the user's additional media playback device to obtain a download of the correct version of the media server application (app) for the specific additional playback device. At step 225, the additional media playback device downloads the specific application software (app) that supports the media service on the specified device.

At step 230, the additional media playback device downloads the application from the URL location and installs the application. In one embodiment, the additional media playback device uses the installed application software (app) and populates the application with user credentials, such as account number and user name, in order to register the additional media playback device with service access. At step 235, the user may now use the additional playback device to access digital content on the media service for which she has an account.

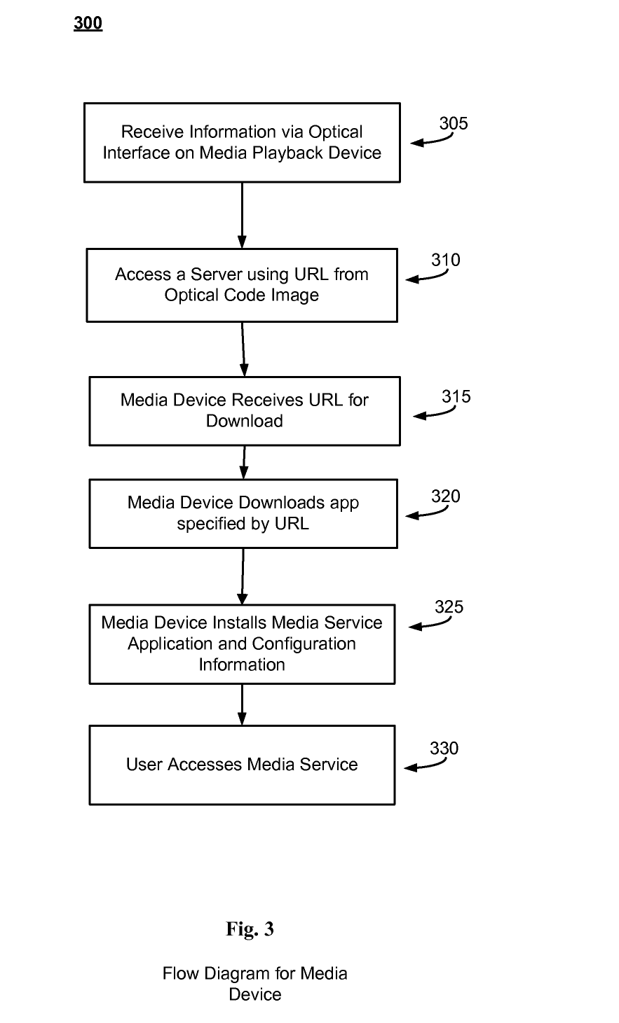

FIG. 3 is a flow diagram representing the activities occurring at the additional media playback device according to aspects of the invention. The method 300 begins at step 305 where the optical interface of the additional media playback device scans the optical code and reads the encoded information of the optical code image. As indicated above, the optical code image, which may be an image of a bar code, a UPC code or a QR code, is scanned and interpreted to have at least the following: the media service name identifier or equivalent; an account number for the media service or a reference equivalent; and an identifier of the additional playback device or a reference equivalent. Reference equivalents may include a numeric or alphanumeric code that may be interpreted via look up table in the media playback device. In addition, the optical code image may also have user credentials in order to register the user for use of the media service via the additional playback device.

In one embodiment, the information embedded into the optical code image may be interpreted to be a universal resource locator (URL). This first URL represented in the optical code image presented to the additional playback device optical interface contains an internet address of the server, such as server 118 of FIG. 1, as well as the media service identifier, account number of the user's media service account, and media playback device identifier. The media playback device identifier may be placed into the optical code image to be part of the URL or as a separate piece of information. In a further extension of the embodiment, the additional information of user credentials is encoded into the optical code image so that the additional playback device can use the information to populate a downloaded media service application and further prepare the additional media playback device for use.

Once the information from the optical code image is read, the first URL present in the decoded optical information is used to access the server 118. As noted above, the additional media playback device identifier and the media service identifier is embedded in the URL intended to access the server 118. The additional media playback device identifier and the media service identifier is data embedded in the URL for the server to use to determine which specific client application software (app) is best suited for the specified additional media playback device compatible with its operating system.

In one aspect of the invention, multiple sets of information for different additional playback devices can be encoded in the optical code image. In this instance, the server would receive multiple URLs from the requesting additional playback device; each specifying a different additional playback device identifier. In this instance, the server would respond to the multiple URLs by requesting that the sending additional playback device send a device identifier to specify to the server which additional playback device is requesting the media service application information.

In either event, at step 315, the server 118 transmits to the requesting additional media playback device a second URL specifying a web address for the version of the media service application (app) suitable for the requesting additional media playback device. At step 320, the additional media playback device uses the received (second) URL from the first server to download the correct media service application (app) suitable for the additional playback device. The media service application may be downloaded from a second server. The second server may be located in any of the following: server 118, the media service provider equipment 102, a local router or gateway 106.

At step 325, the additional playback device installs the media service application (app). In one embodiment, this action completes the set-up of the additional playback device. In a further extension of the embodiment, the media service application (app) is configured within the additional playback device. In this further embodiment, the additional playback device uses the media service account number and user credentials to configure the installed media service application so that the user does not have to enter account or user credentials into the app before using the app for the first time. After such an initial configuration, the user can access the media service at step 330 without having to register the device with the user's account on the media service. If a client application does not exist for a specific media playback device, a URL of a web based version of the media service is provided instead.

In one variation of the above embodiment, the optical code image is generated by an apparatus that is not a playback device. For example, the optical code image can be generated by a computer which is not used as the users first or primary playback device 204. In this instance, the additional playback devices referred to above are all primary media playback devices as far as the user is concerned. As such, they may be referred to simply as media playback devices. The media player device installs the media service application (app) and configures it for operation by a user according to the aspects of the invention. In one embodiment, multiple media services may be encoded in one optical code image for a single media playback device. Also, in another embodiment, one media service can be encoded to support multiple types of media playback devices. For example, one QR code can be used to assist in the setup and configuration of a single media playback device for one or many media services. In addition, a single QR code may be used to setup and configure many media playback devices for a single media service.

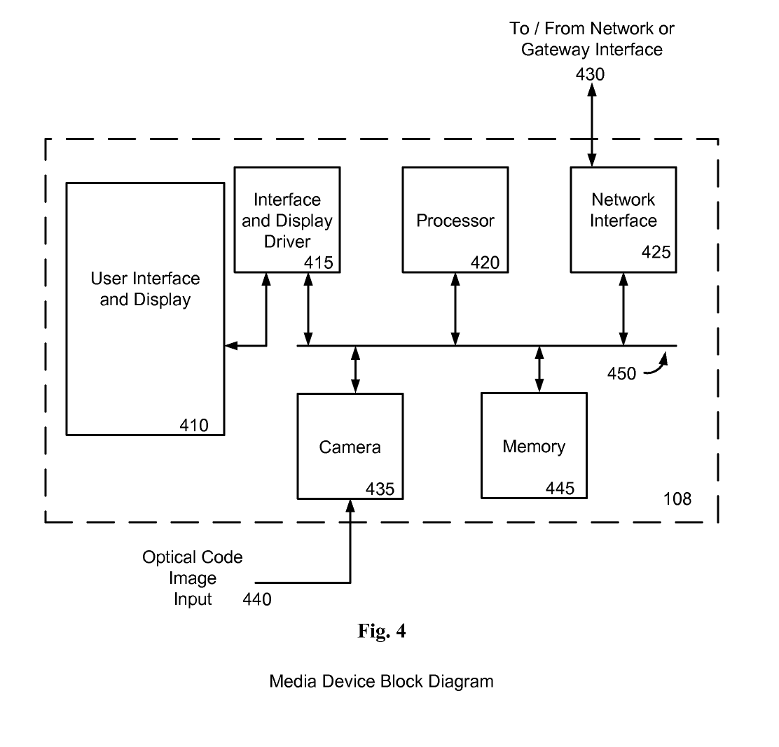

FIG. 4 depicts an example media playback device block diagram 400. Apparatus 400 operates as described for media playback device 108a or 108b of FIG. 1 and as described in example method 300 of FIG. 3. In FIG. 4, the apparatus 400 may typically contain a local user interface 410. A local user interface may include human and electronic interfaces known to those of skill in the art such as a keyboard, mouse, display, USB connections, and the like for a user to conduct programming and apparatus operational control. Apparatus 400 may contain an interface circuit 415 to couple the user interface 410 with the internal circuitry of the device, such as an internal bus 450, as is known in the art. A processor 420 assists in controlling the various interfaces and resources for the apparatus 400. Those resources include a local memory 445 used for program and/or data storage and well as a network interface 425. The network interface connection 430 and the network interface block 425 are used to allow the apparatus 400 to communicate with a network interface such as a gateway and the like. The network in turn, allows apparatus 400 to exchange data with resources on the network. For example, the network interface 430 can be a wired or wireless interface for the functionality described for additional playback devices 108 of FIG. 1. Apparatus 400 also includes an optical image input interface 440 to an optical image reader, such as camera 435, to read optical codes. Apparatus 400 utilizes the processor 420, memory 445, optical reader (camera) 435, and network interface 425 to implement the activities as described in the example flow diagram of FIG. 3. As such, processor 420 directs the activities of the memory 445, optical reader (camera) 435, and network interface 425 to implement the flow diagram activities of FIG. 4.

Although specific architectures are shown for the implementation of a system to automatically configure a media playback device to function with a media service, one of skill in the art will recognize that implementation options exist such as distributed functionality of components, consolidation of components, and use of distributed programming between playback devices and supporting routers, gateways, and servers. Such options are equivalent to the functionality and structure of the depicted and described arrangements.

1. A method performed by a media playback device to load a first application program, the method comprising:
scanning and interpreting an optical code image having information identifying at least one media service, the information comprising a first universal resource locator of a first server and an identifier of the media playback device;
accessing the first server using the first universal resource locator;
receiving a second universal resource locator of a second server from the first server;
downloading the first application program for a first media service from the second server, the first application program being selected by the first server to be compatible with the media playback device and the at least one media service; and
installing the first application program onto the media playback device.

2. The method of claim 1 wherein scanning and interpreting an optical code image having information identifying at least one media service comprises receiving a bar code, QR, or UPC Code.

3. The method of claim 2 wherein receiving a bar code, QR, or UPC Code further comprises receiving the optical code image having encoded thereon a model name and model number as an identifier of the media playback device.

4. The method of claim 1, scanning and interpreting an optical code image having the information comprises receiving the first universal resource locator which contains the identifier of the media playback device.

5. The method of claim 1, wherein the identifier of the media playback device includes information pertaining to the operating system of the media playback device.

6. The method of claim 1 further comprising:
configuring the first application program installed on the media playback device with account information for the at least one media service.

7. The method of claim 6, wherein configuring comprises using account information and user credentials.

8. The method of claim 1, further comprising:
downloading a second application program for a second media service from the second server, the second application program being selected by the first server to be compatible with the media playback device and the second media service; and
installing the second application program onto the media playback device.

9. A media playback device that loads a first application program into memory, the media playback device comprising:
an optical interface for receiving information from an optical code image, the information identifying at least one media service, the information comprising a first universal resource locator and an identifier of the media playback device;
a processor that executes computer instructions to communicate with a network interface acting to access a first server using the first universal resource locator, the first server returning a second universal resource locator of a second server;
memory available to the processor for storing downloaded instructions of the first application program from the second server for a first media service, the first application program being selected by the first server to be compatible with the media playback device and the at least one media service, whereby the processor executes the downloaded instructions and installs the first application program onto the media playback device.

10. The media player device of claim 9 wherein the optical interface receives the information by scanning one of a bar code, a QR code, or a UPC code.

11. The media player device of claim 9 wherein the identifier of the media playback device comprises a model name and model number.

12. The media player device of claim 9 wherein the processor executes instructions to configure the first application program installed on the media player device with account information for the at least one media service.

13. The media player device of claim 9 wherein the processor executes instructions to download and install a second application program for a second media service from the second server, the second application program being selected by the first server to be compatible with the media player device and the second media service.

14. The media player device of claim 9, wherein the first server and the second server are the same server.

15. The media player device of claim 9, wherein the second server is an application server supplying media service applications as downloads to media playback devices.
